(19) United States
(12) Patent Application Publication
(10) Pub. No.: US 2024/0191080 A1
(43) Pub. Date: Jun. 13, 2024

(54) METHOD FOR PRODUCING WATER-SOLUBLE AZO DYES BY CONTINUOUS DIAZOTIZATION AND CONTINUOUS COUPLING IN PIPELINE REACTOR

(71) Applicant: DALIAN UNIVERSITY OF TECHNOLOGY, Dalian, Liaoning (CN)

(72) Inventors: Shufen ZHANG, Dalian, Liaoning (CN); Lei LI, Dalian, Liaoning (CN); Bingtao TANG, Dalian, Liaoning (CN); Rongwen LV, Dalian, Liaoning (CN); Wei MA, Dalian, Liaoning (CN); Suli WU, Dalian, Liaoning (CN); Wenbin NIU, Dalian, Liaoning (CN); Benzhi JU, Dalian, Liaoning (CN)

(21) Appl. No.: 18/546,986

(22) PCT Filed: Sep. 2, 2021
(86) PCT No.: PCT/CN2021/116162

§ 371 Date: Aug. 18, 2023

(30) Foreign Application Priority Data
Aug. 26, 2021 (CN) 202110989819.5

(51) Int. Cl. C09B 29/00; B01J 19/00; B01J 19/18

(52) U.S. Cl. CPC C09B 29/00; B01J 19/0066; B01J 19/1812; B01J 2219/00195

(57) ABSTRACT

A method for producing water-soluble azo dyes by utilizes continuous diazotization reaction and continuous coupling reaction in a pipeline reactor. The diazo component, hydrochloric acid and sodium nitrite are simultaneously fed at the bottom of the pipeline reactor at room temperature, to perform a diazotization reaction in the pipeline and leave the diazotization reaction site in time, followed by performing the coupling reaction with the introduced coupled component. Under stirring of micro stirring blades, the materials at each flow layer are uniformly mixed and reacted, and the reaction materials flow upward under the action of a feed driving force and are discharged from the top of the continuous reactor to produce a water-soluble azo dye.

### TECHNICAL FIELD

The present disclosure relates to a method for continuously producing water-soluble azo dyes, in particular to a method for producing water-soluble azo dyes by continuous diazotization and continuous coupling in a pipeline reactor, belonging to the field of fine chemical engineering.

### BACKGROUND

Diazotization reaction and coupling reaction are two necessary reactions to prepare azo dyes. The diazotization reaction of water-soluble primary arylamines is carried out in the aqueous solution of arylamines, with nitrite as the diazotization reagent, and the nitrite is produced in situ with sodium nitrite and hydrochloric acid in the reaction system. Diazotization reaction theoretically requires equal molar equivalent of sodium nitrite and two molar times of hydrochloric acid. In order to maintain the reaction in an acid environment, excessive hydrochloric acid is usually used. Primary arylamine diazonium salt reacts with aromatic compounds containing amino or hydroxyl on equal molar equivalent in aqueous solution to produce azo compounds, namely the water-soluble azo dyes.

The diazotization reaction of most primary arylamines is a rapid exothermic reaction, and even some primary arylamines complete diazotization reaction in a few seconds when contact with the diazotization reagent. The coupling reaction speed is also very fast under neutral or weak alkaline conditions, and some rapid coupling reactions can also be completed in a few seconds. Traditional production of azo dyes is carried out in batch reactors. In order to improve the production efficiency, the batch reactor is dozens of cubic meters or even hundreds of cubic meters, with only one stirring paddle in the middle. The process of diazotization reaction in the batch reactor includes: firstly adding ice into the reactor, then adding the diazo components of primary arylamine and hydrochloric acid and stirring to mix evenly, and quickly adding 300 g/L of a sodium nitrite solution after the temperature drops below 5° C. for diazotization reaction. Since the speed of the mass and heat transfer is slower than that of the diazotization reaction, a reaction time in hours is generally required to confirm the completion of the reaction. When local of the reaction system lacks diazotization reagent, the produced diazonium salt is easy to quickly convert into relatively stable trans-diazonium acid, or the locally produced diazonium salt is easy to couple with the adjacent and unreacted primary arylamines in the system. The occurrence of these two side reactions will seriously affect the subsequent coupling reaction or other reactions, so as to produce by-products and affect the product quality.

After completion of the diazotization reaction, coupling component is added thereto, and sodium carbonate is added in batches to neutralize the hydrogen chloride produced by the reaction, so as to promote the reaction to proceed forward. Since the reaction is carried out under the stirring of only one stirring anchor, affected by mass transfer, the coupling reaction speed is still controlled by the mass transfer process. The acid-base neutralization heat and the heat released by the reaction cannot be removed in time, and the local unreacted diazonium salt still has an opportunity to become trans-diazonium acid or self-couple to affect the normal coupling reaction and generate reaction impurities. Most reactive dye production enterprises directly spray and dry the high concentration dye aqueous solution produced in batch reactor to obtain dye dry powder, that is, there is no process of separating the reaction impurities in the batch reactor. Therefore, affected by the fluctuation of reaction conditions, the product quality of the diazotization reaction and the coupling reaction completed in the batch reactor is unstable, and the side reactions results in a high impurity content in the product.

In order to solve the above problems existing in the production of azo dyes from batch reactor, science and technology workers at home and abroad have sought solutions from the 1950s. First, the research started from a separate continuous diazotization reaction and continuous coupling reaction, until recent years there have been articles and patents reports on continuous production of azo dyes or pigments by diazotization reaction and coupling reaction together. CHEN Huaxiang prepared disperse dyes by using a self-circulation in kettle and a pipeline reactor device, so that the diazotization and coupling processes has higher mass and heat transfer efficiency; and a cooling jacket and an in-pipe heat exchange device were adopted to change the cooling mode of traditional process coupling reaction, so that the mother liquor wastewater is reduced by 20% [Chen Huaxiang. Research on Automatic Continuous Production Process of Azo Disperse Dyes [D]. East China University of Science and Technology, 2018]. Although Chen realizes continuous feeding and continuous discharging, according to the reaction speed requirement, the reaction materials need to be self-circulated in the kettle to ensure that the coupling reaction is completed during discharging. XU Wanfu et. al and JIA Jianhong et. al realized the continuous production of azo dyes by respectively completing diazotization reaction and coupling reaction in two reactors [CN203269846U, 2013 Nov. 6; CN103146221A, 2013 Jun. 12; CN105363399A, 2016 Mar. 2; CN111303653A, 2020 Jun. 19; and CN110845860A, 2020 Feb. 28], where the diazotization reaction and the coupling reaction are not performed continuously in the same reactor. ZOU Haikui, CHEN Jianfeng et. al realized the continuous preparation of water-soluble dyes by using a high gravity combination device [CN110508231A, 2019 Nov. 29; CN109651843A; and CN109651843B], and essentially, the diazotization reaction and the coupling reaction are not continuously realized in the same reaction equipment at the same time. Wang F J et al. [Chemical Engineering and Processing-process Integration, 2018, 12743-49.], and Yang Lintao and Yan Dongmao et al. used micro reactors to realize the continuous production of azo dyes [Dyes and Dyeing, 2018, 55 (02): 43-45; CN111378297A and CN111378297A], which is not conducive to the continuous reaction of high-concentration turbid reaction materials.

### SUMMARY OF THE INVENTION

The present disclosure provides a method for continuously producing water-soluble azo dyes in a pipeline reactor. In the present disclosure, a diazo component, hydrochloric acid and sodium nitrite are simultaneously fed in a molar ratio at the bottom of the continuous pipeline reactor at room temperature, to perform a diazotization reaction in a pipeline and leave a diazotization reaction site in time, followed by performing a coupling reaction with an introduced coupling component with an preset pH. Under stirring of micro stirring blades, the reaction materials at each flow layer are approximately uniformly mixed and reacted, and flow upwards under the action of a feed driving force and are discharged from the top of the continuous pipeline reactor to produce the water-soluble azo dyes, with a yield of the main product more than 95% and an intensity fluctuation of the dye product not more than 1%. The method of the present disclosure for producing water-soluble azo dyes can adjust the concentration of the reaction solution according to the viscosity of the diazonium salt solution, the maximum mass concentration can reach 20% or more, and the method can operate continuously as required until the production output demand is satisfied. The present disclosure not only solves the problems that it is necessary to add a large amount of ice to maintain the reaction temperature of about 0° C. during the production of azo dyes in a batch reactor, and it is limited by mass and heat transfer, the yield of dye products is unstable and the impurity content is high, but also solves the problem that a high-concentration diazonium salt solution of heterogeneous phase is not easy to flow in a microchannel reactor.

The present disclosure provides a technology for completing continuous diazotization reaction and continuous coupling reaction to produce water-soluble azo dyes in a pipeline reactor with a plurality of micro stirring blades distributed along an axial direction thereof. At room temperature, material solutions participating in the diazotization reaction are fed from an inlet at a bottom of the pipeline reactor with a plurality of micro stirring blades distributed along the axial direction thereof. When detects that, at a sampling port of the pipeline reactor, the diazotization reaction is completed and diazonium salt is produced, a coupling component solution with a preset pH is input from an inlet adjacent to above the sampling port, so that the coupling component solution meets the diazonium salt solution followed by uniformly mixing under the stirring of the micro stirring blades to perform the coupling reaction to produce the water-soluble azo dyes, and the water-soluble azo dyes are discharged from a top of the pipeline reactor.

Further, the method includes the following steps:
S1. Input, at room temperature, a diazo component, sodium nitrite and a hydrochloric acid solution in a molar ratio of 1:1.05: (2.10 to 2.30) and at a flow rate of less than 50 mL/min after metering into the bottom of the pipeline reactor with a plurality of built-in micro stirring blades distributed along the axial direction for diazotization reaction, and the material solutions flow upward under the action of feed driving force;
S2. Detect in real time through the sampling ports during the reaction to determine a position of the pipeline reactor where the reaction solution is located when the diazotization reaction is completed;
S3. Input, at room temperature, the coupling component with a preset pH after accurate metering into the inlet adjacent to above the sampling port where the diazotization reaction is completed, and the coupling component and the diazo component carry out the coupling reaction and flow upward under the action of feed driving force, where a molar ratio of the coupling component to the diazo component is 1:1;
S4. Discharge the water-soluble azo dye solution produced in the pipeline reactor from the top thereof to obtain the produced dye solution.

Further, when continuous diazotization reaction and continuous coupling reaction are carried out in a pipeline reactor, the mix of the material solutions is performed by the built-in micro stirring blades distributed along the axial direction.

Further, the diazotization reaction with a solution concentration of the diazo component higher than 200 g/L and the coupling reaction with a concentration of the coupling component higher than 200 g/L can be carried out in the pipeline reactor.

### Beneficial Effects

(1) In the present disclosure, for the continuous diazotization reaction and continuous coupling reaction performed in the pipeline reactor, the material solutions are fed from the bottom and middle of the reactor and the product is discharged from the top of the reactor.
(2) In the present disclosure, for the continuous diazotization reaction and the continuous coupling reaction performed in the pipeline reactor, the mix of the material solutions is performed by a plurality of micro stirring blades distributed along the axial direction.
(3) In the present disclosure, the status of the diazotization reaction is detected at different sampling ports of the pipeline reactor. After confirming the diazotization reaction is completed by using the test paper sets provided in PCT/CN2020/127451 or ZL 202010819724.4, the coupling component solution with a preset pH is input for coupling reaction from the inlet adjacent to above the sampling port.
(4) In the present disclosure, the diazotization reaction with a solution concentration of the diazo component higher than 200 g/L and the coupling reaction with a solution concentration of the coupling component higher than 200 g/L can be carried out in the pipeline reactor, and the concentration of the reaction solutions can be adjusted according to the viscosity or turbidity of the produced water-soluble azo dye diazonium salt solution.
(5) In the present disclosure, all materials can enter the pipeline reactor at room temperature without condensation or heating.

### DETAILED DESCRIPTION OF DRAWINGS

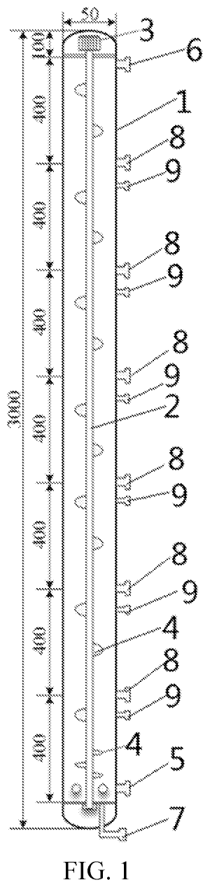

FIG. 1 shows a pipeline reactor with a plurality of built-in micro stirring blades distributed along the axial direction,
wherein, 1—pipe body, 2—rotating shaft, 3—motor, 4—micro stirring blade, 5—inlet I, 6—top discharge port, 7—bottom discharge port, 8—inlet II, 9—sampling port.

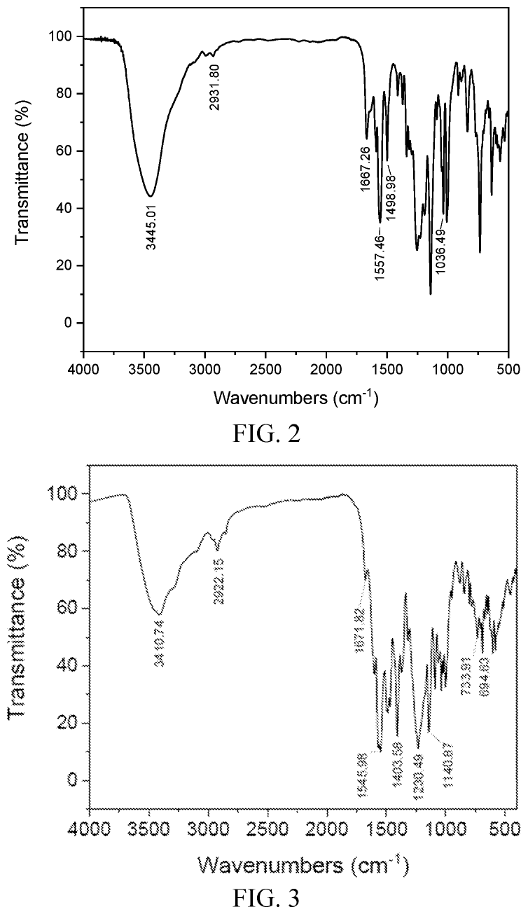

FIG. 2 shows an infrared spectrogram of a yellow monoazo dye.

FIG. 3 shows an infrared spectrogram of a reactive yellow M-5G azo dye.

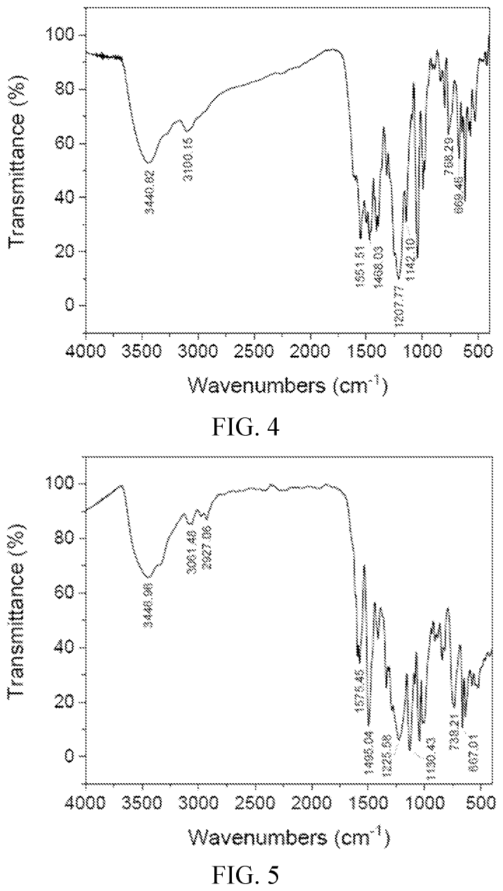

FIG. 4 shows an infrared spectrogram of a reactive red M-3B azo dye.

FIG. 5 shows an infrared spectrogram of a reactive black KN-B azo dye.

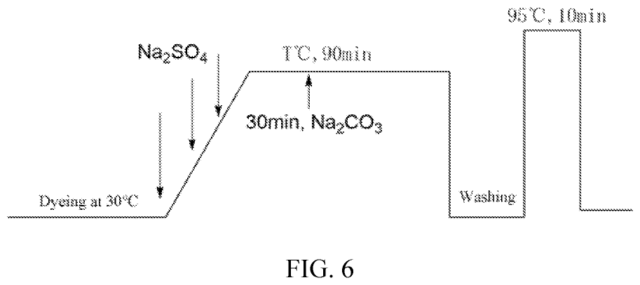

FIG. 6 shows a dyeing curve.

### DETAILED DESCRIPTION OF PREFERRED EMBODIMENTS

A detailed description of the present disclosure will be presented in conjunction with the embodiments, but the described embodiments are only some embodiments of the present disclosure, which cannot be used as a basis for limiting the present disclosure. Non-essential changes made on the basis of the present disclosure are still within the protection scope of the present disclosure.

In the following embodiments, unless otherwise specified, all flow units used are mL/min.

The structure of the pipeline reactor with a plurality of built-in micro stirring blades distributed along the axial direction provided in the embodiments of the present disclosure is shown as FIG. 1. The pipeline reactor is a vertical pipeline reactor, including a pipe body 1, a rotating shaft 2 disposed at the inner central axis of the pipe body 1, a motor 3 disposed at the top of the rotating shaft 2, a plurality of micro stirring blades 4 disposed on the rotating shaft 2, a feed inlet I 5 disposed on the side of the bottom of the pipeline reactor, a top discharge port 6 disposed on the side of the top of the pipeline reactor, and a bottom discharge port 7 disposed at the bottom of the pipeline reactor. Several groups of inlets II and sampling ports are disposed on the side of the pipeline reactor between the top discharge port 6 and the inlet I 5, with an equal spacing between inlet II and sampling port of each group. In each group of inlet II and sampling port, the inlet II 8 is located adjacent to above the sampling port 9.

When in use, the materials enter the pipeline reactor from the inlet I, the rotating shaft driven by the motor drives the micro stirring blades to rotate, and the materials flow upward under the action of feed driving force in the reactor and the diazotization reaction is carried out at the same time. Real time detection is carried out through the sampling ports during the reaction to determine a position of the pipeline reactor where the reaction solution is located when the diazotization reaction is completed. The coupling component is input at room temperature into the inlet adjacent to above the sampling port where the diazotization reaction is completed, and the diazonium salt and the coupling component carry out the coupling reaction and flow upward under the action of feed driving force. The water-soluble azo dyeing solution produced in the pipeline reactor is discharged from the top of the pipeline reactor to obtain the produced dyeing solution. The remaining materials in the reactor can be discharged from the bottom discharge port after completion of the reaction.

### Embodiment 1

A monoazo water-soluble yellow dye is prepared by using para-ester as a diazo component and 1-(4-sulfopheny)-3-methyl-5-pyrazolone as a coupling component, and the reaction formula is as follows:

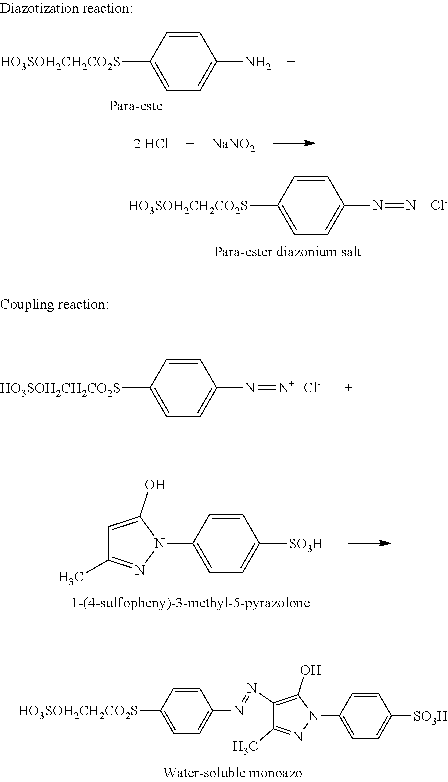

A para-ester solution (257.2 g/L), a sodium nitrite solution (300 g/L), a hydrochloric acid solution (125.6 g/L), and a 1-(4-sulfopheny)-3-methyl-5-pyrazolinone solution (219.7 g/L) with an initial pH of 9 were prepared for standby.

The prepared material solutions were accurately input, at flow rates of the hydrochloric acid solution of 282 mL/min, the sodium nitrite solution of 110.55 mL/min and the para-ester solution of 500 mL/min, from the bottom of the pipeline reactor with a plurality of built-in micro stirring blades distributed along the axial direction to carry out the diazotization reaction. After 2 minutes, sampling was performed at the sampling ports to detect whether or not the diazotization reaction was completed by using the test paper sets provided in PCT/CN2020/127451 or ZL202010819724.4. After completion of the diazotization reaction, the 1-(4-sulfopheny)-3-methyl-5-pyrazolone solution with an initial pH of 9 was accurately input, at a flow rate of 529.19 mL/min, from the inlet adjacent to above the sampling port where detected that the diazotization reaction was completed for coupling reaction, and the product solution flowed into the storage tank from the discharge port at the top of the pipeline reactor for sampling and analysis.

By detecting with Hewlett-Packard (HP) 1260 liquid chromatograph at a wavelength of 430 nm, the content of the dye product in the product solution was 95.61%. The infrared spectrogram is shown in FIG. 2, in which the peak at 3445.01 cm⁻¹ is O—H stretching vibration peak, the peak at 2931.80 cm⁻¹ is C—H stretching vibration peak, the peak at 1667.26 cm⁻¹ is C═O stretching vibration peak, the peaks at 1557.46 cm⁻¹ and 1498.98 cm⁻¹ are benzene ring C═C stretching vibration peaks, and the peak at 1036.49 cm⁻¹ is sulfonate S═O symmetric stretching vibration peak. The results of the mass spectrometry analysis are of 545.1=[M−H]⁻, 272.1=[M−2H]²⁻, 567.1=[M−2H+Na]⁻, and 283.1=[M−3H+Na]²⁺.

### Embodiment 2

Except for the coupling component solution with an initial pH of 10, all the other operations were performed according to Embodiment 1. The content of the dye product in the product solution was 95.98%.

### Embodiment 3

Except for the coupling component solution with an initial pH of 11, all the other operations were performed according to Embodiment 1. The content of the dye product in the product solution was 96.07%.

### Embodiment 4

Except for the coupling component solution with an initial pH of 12, all the other operations were performed according to Embodiment 1. The content of the dye product in the product solution was 97.04%.

### Embodiment 5

Except for the coupling component solution with an initial pH of 13, all the other operations were performed according to Embodiment 1. The content of the dye product in the product solution was 93.17%.

### Embodiment 6

The raw material solutions prepared in Embodiment 1 were accurately input, at flow rates of the hydrochloric acid solution of 565 mL/min, the sodium nitrite solution of 221 mL/min and the para-ester solution of 1000 mL/min, from the bottom of the pipeline reactor to carry out the diazotization reaction. After 1 minute, sampling was performed at the sampling ports to detect whether or not the diazotization reaction was completed. After confirming the completion of the diazotization reaction, the 1-(4-sulfopheny)-3-methyl-5-pyrazolinone solution with an initial pH of 12 was accurately input, at a flow rate of 1058 mL/min, from the inlet adjacent to above the sampling port where detected that the diazotization reaction was completed for coupling reaction, and the product solution flowed into the storage tank from the discharge port at the top of the pipeline reactor for sampling and analysis.

By detecting with HP 1260 liquid chromatograph at a wavelength of 430 nm, the content of the dye product in the product solution was 95.36%.

### Embodiment 7

Continuous synthesis of a reactive yellow M-5G dye:

A reactive yellow M-5G dye is continuously prepared by using a di-condensate (condensed by cyanuric chloride with para-ester and m-phenylenediamine sulfonic acid respectively) as a diazo component and 1-(2,5-dichloro-4-sulfopheny)-3-methyl-5-pyrazolone as a coupling component. The reaction formula is as follows:

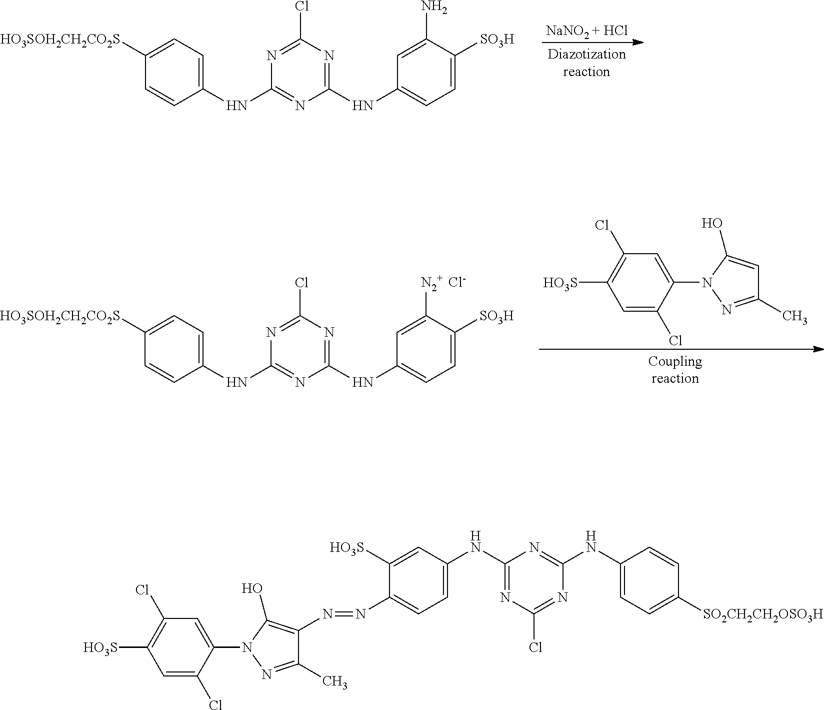

A di-condensate solution (80.62 g/L) condensed by cyanuric chloride with para-ester and m-phenylenediamine sulfonic acid, a sodium nitrite solution (30.0 g/L), a hydrochloric acid solution (33.62 g/L), and a 1-(2,5-dichloro-4-sulfo benzene)-3-methyl-5-pyrazolone solution (257.6 g/L) with an initial pH of 9 were prepared for standby.

The prepared material solutions were accurately input, at flow rates of the hydrochloric acid solution of 327.41 mL/min, the sodium nitrite solution of 335.7 mL/min and the di-condensate solution condensed by cyanuric chloride with para-ester and m-phenylenediamine sulfonic acid of 1000 mL/min, from the bottom of the pipeline reactor to carry out the diazotization reaction. After 1 minute and 13 seconds, sampling was performed at the sampling ports to detect whether or not the diazotization reaction was completed by using the test paper sets provided in PCT/CN2020/127451 or ZL202010819724.4. After completion of the diazotization reaction, the 1-(2,5-dichloro-4-sulfopheny)-3-methyl-5-pyrazolone solution with an initial pH of 9 was accurately input, at a flow rate of 172.01 mL/min, from the inlet adjacent to above the sampling port where detected that the diazotization reaction was completed for coupling reaction, and the product solution flowed into the storage tank from the discharge port at the top of the pipeline reactor for sampling and analysis.

By detecting with HP 1260 liquid chromatograph at a wavelength of 406 nm, the content of the dye product in the product solution was 97.8%. The infrared spectrogram is shown in FIG. 3, in which the peak at 3410.74 cm⁻¹ is O—H stretching vibration peak, the peak at 2922.15 cm⁻¹ is C—H stretching vibration peak, the peak at 1671.82 cm⁻¹ is C═O stretching vibration peak, the peaks at 1545.98 cm⁻¹ and 1403.58 cm⁻¹ are benzene ring C═C stretching vibration peaks, and the peaks at 1230.49 cm⁻¹ and 1140.87 cm⁻¹ are sulfonate S═O symmetric stretching and flexural vibration peaks. The results of the mass spectrometry analysis are of 303.5=[M−3H]/3, 455.5=[M−2H]/2, and 466.5=[M+Na−2H]/2.

### Embodiment 8

Continuous synthesis of a reactive yellow M-5G dye:

By using a mono-condensate (condensed by cyanuric chloride with m-phenylenediamine sulfonic acid) as a diazo component and 1-(2,5-dichloro-4-sulfopheny)-3-methyl-5-pyrazolone as a coupling component, the monoazo water-soluble yellow dye is continuously prepared, followed by carrying out a di-condensation reaction with para-ester. The reaction formula is as follows:

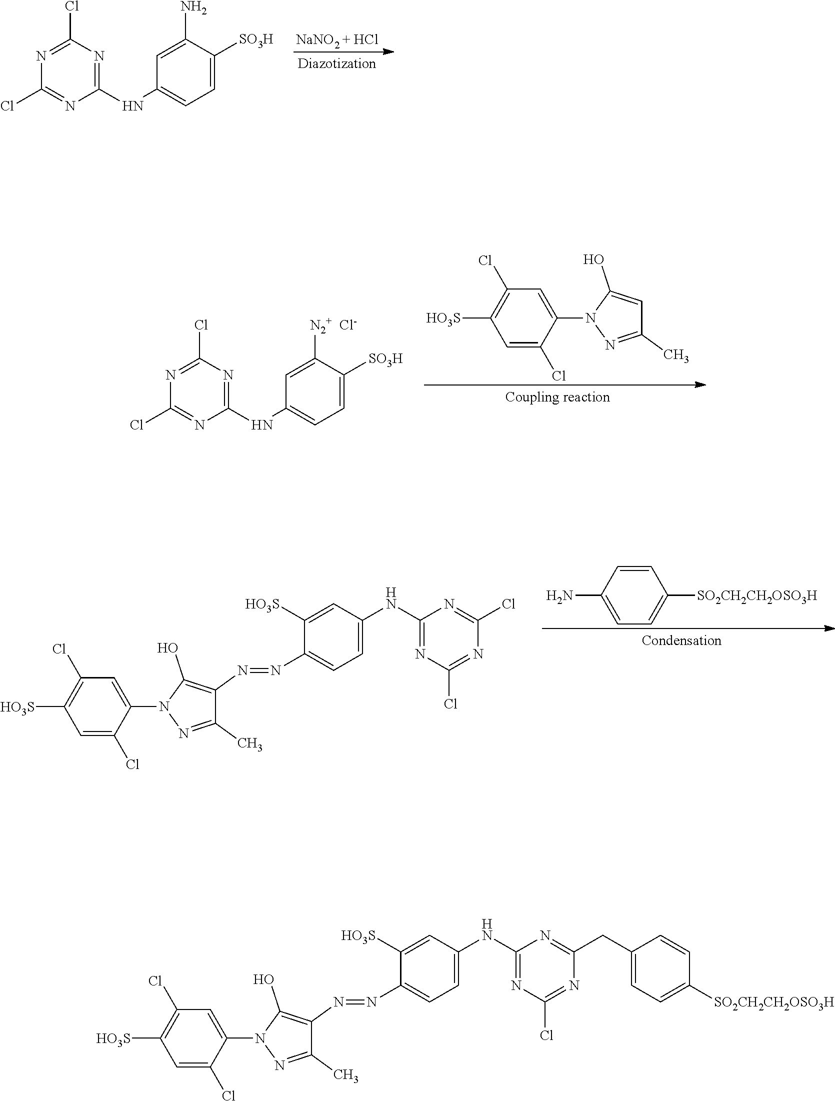

A mono-condensate solution (262.4 g/L) condensed by cyanuric chloride with m-phenylenediamine sulfonic acid, a sodium nitrite solution (300 g/L), a hydrochloric acid solution (221.0 g/L), and a 1-(2,5-dichloro-4-sulfopheny)-3-methyl-5-pyrazolone solution (257.6 g/L) with an initial pH of 10 were prepared for standby.

The prepared material solutions were accurately input, at flow rates of the hydrochloric acid solution of 265.0 mL/min, the sodium nitrite solution of 190.38 mL/min and the mono-condensate solution condensed by cyanuric chloride with m-phenylenediamine sulfonic acid of 1000 mL/min, from the bottom of the pipeline reactor to carry out the diazotization reaction. After 1 minute and 20 seconds, sampling was performed at the sampling ports to detect whether or not the diazotization reaction was completed by using the test paper sets provided in PCT/CN2020/127451 or ZL202010819724.4. After completion of the diazotization reaction, the 1-(2,5-dichloro-4-sulfopheny)-3-methyl-5-pyrazolone solution with an initial pH of 10 was accurately input, at a flow rate of 975 mL/min, from the inlet adjacent to above the sampling port where detected that the diazotization reaction was completed for coupling reaction, and the product solution flowed into the storage tank from the discharge port at the top of the pipeline reactor for sampling and analysis.

By detecting with HP 1260 liquid chromatograph at a wavelength of 510 nm, the content of the mono-condensate dye product in the product solution was 97.0%.

2300 mL, 215.3 g/L of the water-soluble azo dye prepared by continuous diazotization reaction and continuous coupling reaction using the mono-condensate condensed by cyanuric chloride and m-phenylenediamine and 666.7 mL, 312.5 g/L of the para-ester solution were subjected to a di-condensation reaction at 30° C. and pH 6 to 6.5 for 3 hours, followed by sampling and analysis. By detecting with HP 1260 liquid chromatograph at a wavelength of 510 nm, the content of the mono-condensate dye product in the product solution was 93.9%.

### Embodiment 9

Continuous synthesis of a reactive red M-3BE dye:

The reactive red M-3BE dye is continuously prepared by using sulpho tobias acid as a diazo component and a di-condensate (condensed by cyanuric chloride with para-ester and H-acid (1-amino-8-hydroxynaphthalene-3,6-disulfonic acid) respectively) as a coupling component. The reaction formula is as follows:

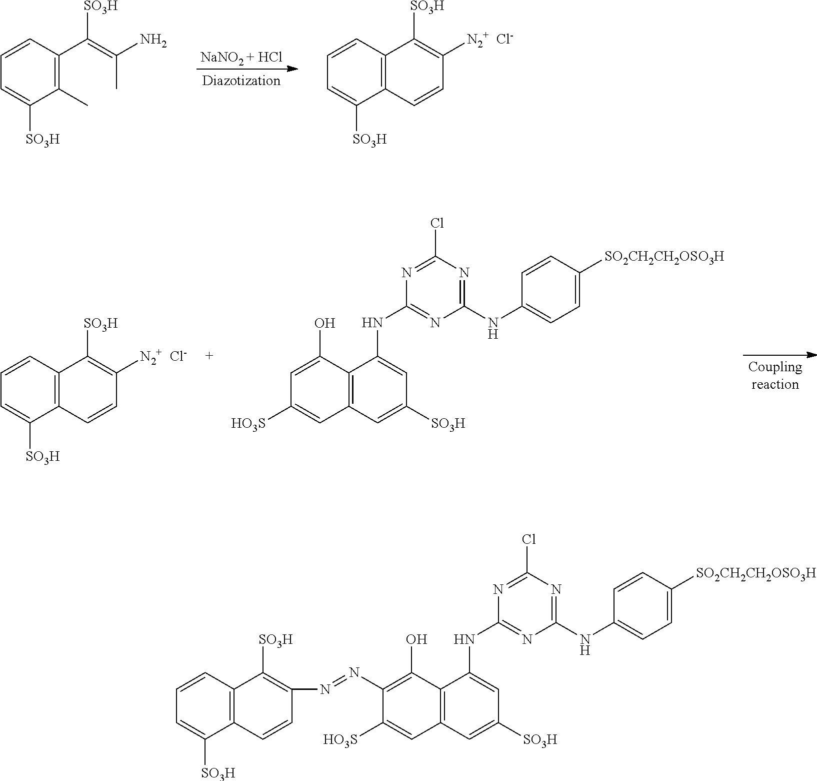

A molar ratio of hydrochloric acid to sulpho tobias acid of 1:2.15, a sodium nitrite solution (300 g/L), a sulfonated toast acid solution (123.92 g/L), and a di-condensate solution (239.38 g/L, with an initial pH of 10) condensed by cyanuric chloride with para ester and H-acid were prepared for standby.

The prepared material solutions were accurately input, at flow rates of the sodium nitrite solution of 98.77 mL/min and the acidic solution of sulpho tobias acid of 1000 mL/min, from the bottom of the pipeline reactor to carry out the diazotization reaction. After 1 minute and 48 seconds, sampling was performed at the sampling ports to detect whether or not the diazotization reaction was completed by using the test paper sets provided in PCT/CN2020/127451 or ZL202010819724.4. After completion of the diazotization reaction, the di-condensate solution (condensed by cyanuric chloride with and para-ester and H-acid respectively) with an initial pH of 8 was accurately input, at a flow rate of 1214.8 mL/min, from the inlet adjacent to above the sampling port where detected that the diazotization reaction was completed for coupling reaction, and the product solution flowed into the storage tank from the discharge port at the top of the pipeline reactor for sampling and analysis.

By detecting with HP 1260 liquid chromatograph at a wavelength of 510 nm, the content of the dye product in the product solution was 93.4%. The infrared spectrogram is shown in FIG. 4, in which the peak at 3440.82 cm⁻¹ is O—H stretching vibration peak, the peak at 3100.15 cm⁻¹ is C—H stretching vibration peak, the peaks at 1551.51 cm⁻¹ and 1468.03 cm⁻¹ are benzene ring C═C stretching vibration peaks, and the peaks at 1207.77 cm⁻¹ and 1142.10 cm⁻¹ are sulfonate S═O symmetric stretching and flexural vibration peaks. The results of the mass spectrometry analysis are of 255.3=[M−4H]/4, 260.9=[M+Na−4H]/4, and 353.4=[M+K−3H]/3.

### Embodiment 10

Continuous synthesis of a reactive black KN-B dye:

H-acid diazo dye reactive black KN-B is continuously prepared by using para-ester as a diazo component and H-acid as a coupling component.

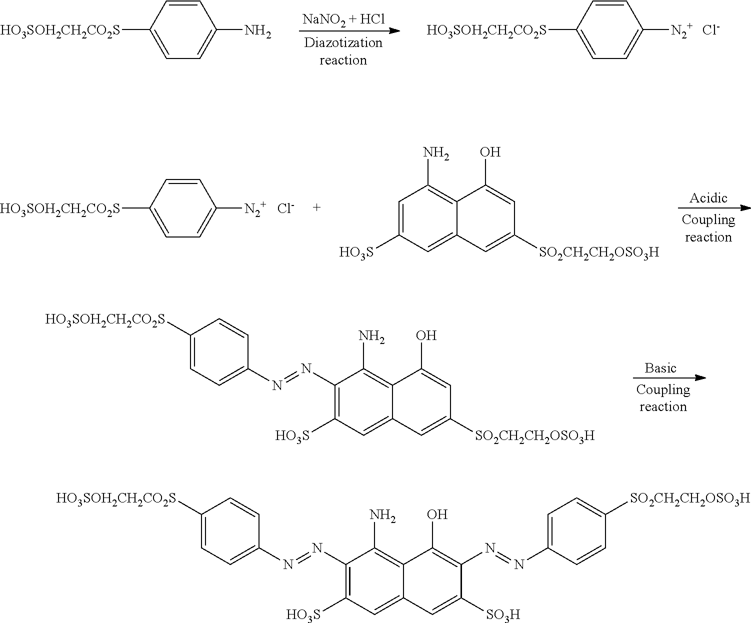

A para-easter solution (394.5 g/L), a sodium nitrite solution (300 g/L), a hydrochloric acid solution (221.0 g/L), a sulfamic acid solution (145.6 g/L) and a H-acid solution (340.5 g/L) with an initial pH of neutral were prepared for standby.

The prepared material solutions were accurately input, at flow rates of the sodium nitrite solution of 336.17 mL/min, the sodium nitrite solution of 237.33 mL/min and the para-ester solution of 700 mL/min, from the bottom of the pipeline reactor to carry out the diazotization reaction. After 1 minute, sampling was performed at the sampling ports to detect whether or not the diazotization reaction was completed by using the test paper sets provided in PCT/CN2020/127451 or ZL202010819724.4. After completion of the diazotization reaction, the sulfamic acid was accurately input, at a flow rate of 80 mL/min, into the pipeline reactor from the inlet adjacent to above the sampling port where detected that the diazotization reaction was completed to destroy excess sodium nitrite. After 1 minute and 38 seconds, the H-acid solution with an initial pH of neutral was accurately input for coupling reaction at a flow rate of 475.7 mL/min from the inlet above the sulfamic acid inlet, and the product solution flowed into the storage tank from the discharge port at the top of the pipeline reactor for sampling and analysis. After continuing to stir the product solution for 1 hour, sodium bicarbonate was used to adjust the pH of the product solution to 6.5 within 2 hours until the pH was stable, and then sampling was performed for analysis.

By detecting HP 1260 liquid chromatograph at a wavelength of 510 nm, the content of the dye product in the product solution was 96.8%. The infrared spectrogram is shown in FIG. 5, in which the peak at 3446.96 cm⁻¹ is O—H stretching vibration peak, the peak at 3061.48 cm⁻¹ is naphthalene ring C—H stretching vibration peak, the peak at 2927.06 cm⁻¹ is C—H stretching vibration peak from methyl, the peaks at 1575.45 cm⁻¹ and 1459.04 cm⁻¹ are benzene ring C═C stretching vibration peaks, and the peaks at 1225.58 cm⁻¹ and 1130.43 cm⁻¹ are sulfonate S═O symmetric stretching and flexural vibration peaks. The results of the mass spectrometry analysis are of 224.9=[M−4H]/4 and 300=[M−3H]/3.

### Embodiment 11 Dyeing Performance of Continuously Prepared Dyes on Cotton Fibers

The dyes prepared in Embodiments 7, 9 and 10 were respectively tested for dyeing performance.

The dyeing curve is shown in FIG. 6, with a fixation temperature of 60° C.

An appropriate amount of dye was taken to prepare a dye solution. 2 g of cotton fiber accurately weighed was taken and immersed in 20 mL of a dye solution to dye, and a cloth sample was obtained. After completion of the dyeing, the cloth sample was washed with water and the residual liquid was collected to measure its absorbance A₁. The washed cloth sample was placed in a 0.1% soap solution to boil at 95° C. for 10 minutes. Then the cloth sample was taken out and washed fully, and the residual liquid was collected to measure its absorbance A₂. In addition, 1 mL of the original dye solution was diluted to 100 mL to measure its absorbance A₀.

The dye and the fiber are bonded by covalent bond, and a exhaustion rate, a fixation rate and a reaction rate thereof are calculated according to the following formulas:

$$E = ( 1 - \frac{{n}_{1} {A}_{1}}{{n}_{0} {A}_{0}} ) \times 100 \% \\ F = ( 1 - \frac{{n}_{1} {A}_{1} + {n}_{2} {A}_{2}}{{n}_{0} {A}_{0}} ) \times 100 \% \\ R = \frac{F}{E} \times 100 \%$$

wherein, E, F and R respectively represent the extraction rate, the fixation rate and the reaction rate (100%); A₀, A₁ and A₂ respectively represent the absorbance of the original dye solution, the dyeing residual liquid and the soaping residual liquid; and n₀, n₁ and n₂ respectively represent the corresponding dilution multiple of the original dye solution, dyeing residual liquid and soaping residual liquid.

Color fastness to rubbing is tested according to GB/T 3920-2008, and color fastness to washing is tested according to GB/T 3921-2008.

According to the above dyeing conditions, the dyeing and fastness test results of the three dyes are shown in the table below.

TABLE 1
Dyeing and fastness test results of continuously prepared dyes

| | | | | | | Fastness to washing/grade | | |
|---|---|---|---|---|---|---|---|---|
| | | | | Fastness to | | Color | | |
| | | Dye-uptake | Fixation | rubbing/grade | | change of the | Cotton | Wool |
| Embodiment | Dye name | % | rate % | Dry | Wet | original cloth | staining | staining |
| Embodiment 7 | Continuous | 70.0 | 57.1 | 4-5 | 4-5 | 4 | 4-5 | 4-5 |
| | reactive | | | | | | | |
| | yellow M-5G | | | | | | | |
| Embodiment 9 | Continuous | 90.1 | 75.4 | 4-5 | 3-4 | 4-5 | 4-5 | 4-5 |
| | reactive red | | | | | | | |
| | M-3BE | | | | | | | |
| Embodiment 10 | Continuous | 90.6 | 83.5 | 4-5 | 3 | 4-5 | 4-5 | 4-5 |
| | reactive black | | | | | | | |
| | KN-B | | | | | | | |

1. A method for producing water-soluble azo dyes by continuous diazotization reaction and continuous coupling reaction in a pipeline reactor, wherein, at room temperature, material solutions participating in a diazotization reaction are fed from an inlet at a bottom of the pipeline reactor with a plurality of built-in micro stirring blades distributed along an axial direction thereof, when detects that, at a sampling port of the pipeline reactor, the diazotization reaction is completed and diazonium salt is produced, a coupling component solution with a preset pH is input from an inlet adjacent to above the sampling port, so that the coupling component solution meets the diazonium salt solution followed by uniformly mixing under the stirring of the micro stirring blades to perform the coupling reaction to produce the water-soluble azo dyes which are discharged from a top of the pipeline reactor.

2. The method according to claim 1, comprising the following steps of:
S1. inputting, at room temperature, a diazo component, sodium nitrite and a hydrochloric acid in a molar ratio of 1:1.05: (2.10 to 2.30) after metering into the bottom of the pipeline reactor with a plurality of built-in micro stirring blades distributed along the axial direction for diazotization reaction, and the material solutions flowing upward under the action of feed driving force;
S2. detecting in real time through the sampling ports during the reaction process to determine a position of the pipeline reactor where the reaction solution is located when the diazotization reaction is completed;
S3. inputting, at room temperature, the coupling component with a preset pH after accurate metering into the inlet adjacent to above a sampling port where the diazotization reaction is completed, wherein a molar ratio of the coupling component to the diazo component is 1:1, and the coupling component and the diazo component carrying out the coupling reaction and flowing upward under the action of feed driving force; and
S4. discharging the water-soluble azo dye solution produced in the pipeline reactor from the top thereof to obtain the produced dye solution.

3. The method according to claim 1, when continuous diazotization reaction and continuous coupling reaction are carried out in the pipeline reactor, the mix of the material solutions is performed by the built-in micro stirring blades distributed along the axial direction.

4. The method according to claim 1, wherein the diazotization reaction with a solution concentration of the diazo component higher than 200 g/L and the coupling reaction with a solution concentration of the coupling component higher than 200 g/L can be carried out in the pipeline reactor.
